(19) United States
(12) Patent Application Publication
(10) Pub. No.: US 2005/0075955 A1
(43) Pub. Date: Apr. 7, 2005

(54) Order fulfillment architecture having an electronic customs invoice system

(76) Inventors: Peggy Milovina-Meyer, Cupertino, CA (US); Edward W Lungren, Plum Avenue Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/490,298

(22) PCT Filed: Oct. 1, 2001
(86) PCT No.: PCT/US01/30687

(51) Int. Cl. G06F 17/60

(52) U.S. Cl. 705/30

(57) ABSTRACT

An order fulfillment architecture which includes an order processing system configured to receive order information and to create an order request usmg the order information, a central processing system configured to receive the order request, to verify the accuracy of the order request, and to organize the order request into a plurality of categories, and a system configured to generate a billing statement using the order request. The order fulfillment architecture further includes a server configured to receive a billing file that is generated using information from the billing statement, to create an electronic file that has a customs invoice for a particular country using information from the billing file, and to transmit the electronic file via email.

### CROSS-REFERENCE TO RELATED APPLICATION

The following application and this application are being filed concurrently, and the disclosure of the following application is incorporated by reference into this application for all purposes: U.S. patent application Ser. No. ______(Attorney Docket No. 10002302-1), entitled “Regulatory Classification System”, filed Oct. 1, 2001.

### BACKGROUND OF THE INVENTION

1. Field of the Invention

The present invention relates generally to a customs invoice and, more particularly, to an order fulfillment architecture having an electronic customs invoice system.

2. Description of the Related Art

Transporting goods and supplies from one country to another has become very common. For example, goods are often manufactured in one country and then shipped to and sold in another country. Once the goods are manufactured, the shipping entity prepares a billing invoice, which includes billing information such as the name and address of the shipping entity, the name and address of the purchasing entity, the name and address of the consignee, a marketing description of the goods, the value of the goods, and the quantity of the goods. The billing invoice is either attached to the goods before they are transported to the consignee or electronically sent to the consignee.

Upon arrival of the goods at the port of destination, the carrier's representative notifies the customs broker that the goods have arrived. The goods are temporarily held in a bonded area until released by customs. A customs broker is hired by the purchasing entity to prepare and submit the customs declaration. The customs broker prepares the customs declaration using information on the billing invoice, airway bill, packing list, and other related documents. The customs declaration is a form that is unique to each individual country and includes information that describes details about the goods or shipment to the particular country. For example, the customs declaration will include a classification number (also referred to as a harmonized tariff schedule (HTS) number) representing the category of the goods, a commercial description of the goods, and the value of the goods.

The local HTS is used to assist customs brokers with classifying goods. The local HTS includes a list of goods with a corresponding classification number. Generally, each classification number is 10 characters in length, where the last 4 characters are determined by each country's local interpretation of the goods. Accordingly, each country has its own unique HTS, e.g., the Mexico HTS. With each country having its own interpretations of the HTS, several different classification numbers can be assigned to the same type of goods. Hence, it is difficult to have a centrally assigned classification number system. To make the classification task even more difficult, the classification numbers are periodically modified.

After the customs declarations are completed, the customs broker calls the customs inspector or stands in a line waiting for the customs inspector to review the customs declaration and the accompanying documents and to clear the shipment. Alternatively, the customs broker may be allowed to electronically submit the customs declaration for review and clearance of the shipment.

It should therefore be appreciated that there is a need for an order fulfillment architecture having an electronic customs invoice system configured to accurately assign HTS numbers, the acceptable description of the goods, and the representation of the value of goods. The present invention fulfills this need as well as others.

### SUMMARY OF THE INVENTION

An order fulfillment architecture which includes an order processing system configured to receive order information and to create an order request using the order information, a central processing system configured to receive the order request, to verify the accuracy of the order request, and to organize the order request into a plurality of categories, and a system configured to generate a billing statement using the order request. The order fulfillment architecture further includes a server configured to receive a billing file that is generated using information from the billing statement, to create an electronic file that has a customs invoice for a particular country using information from the billing file, and to transmit the electronic file via email.

Advantages of the present invention include providing an order fulfillment architecture having an electronic customs invoice system configured to accurately assign a local HTS number, the acceptable description of the goods, and the representation of the value of goods.

Other features and advantages of the present invention should become apparent from the following description of the preferred embodiment, taken in conjunction with the accompanying drawings, which illustrate, by way of example, the principles of the present invention.

### BRIEF DESCRIPTION OF THE DRAWINGS

Embodiments of the present invention will now be described, by way of example only, with reference to the following drawings in which:

FIG. 1 is a simplified block diagram of an order fulfillment architecture having an electronic customs invoice system; and

FIG. 2 is a simplified block diagram of the client device of the electronic customs invoice system of FIG. 1.

### DESCRIPTION OF THE PREFERRED EMBODIMENT

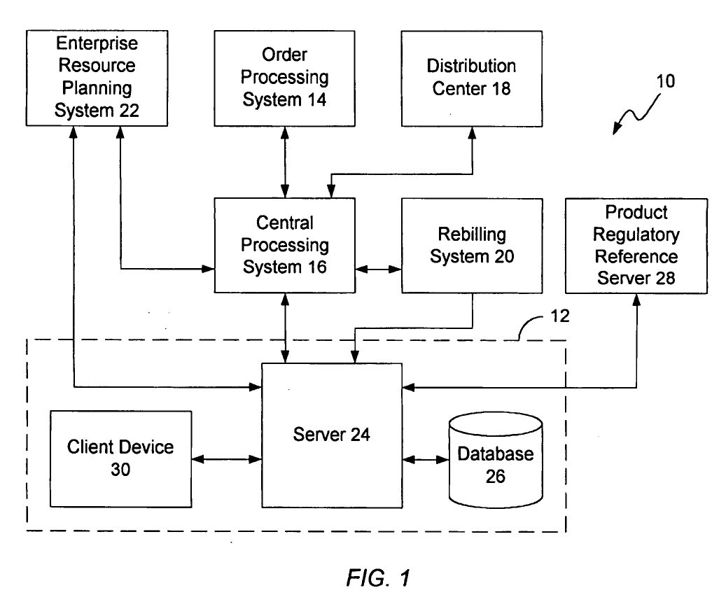

With reference to the illustrative drawings, and particularly to FIG. 1, there is shown a simplified block diagram of an order fulfillment architecture 10 having an electronic customs invoice system 12. The order fulfillment architecture includes an order processing system 14, a central processing system 16, a distribution center 18, a rebilling system 20, an enterprise resource planning (ERP) system 22, a server 24, a database 26, a product regulatory reference server 28, and a client device 30. The electronic customs invoice system includes the server, the database, and the client device. The connections between these components and systems are shown using arrows, which may represent a network, physical, fiber optic, wireless, or any other type of connection. Furthermore, even though one order processing system, one central processing system, one distribution center, one rebilling system, one enterprise resource planning system, one server, one database, one product regulatory reference server, and one client device are depicted, any number of systems, servers, databases, centers, and devices can be used. The order fulfillment architecture may be implemented using hardware, software, or a combination of the two. For example, the order fulfillment architecture may be implemented using existing hardware entirely, making appropriate software updates.

Preferably, the order processing system 14 is a SAP system, Oracle system, or Legacy computer system. The order processing system 14 is configured to receive, modify, and store order information. The order processing begins when a user inputs order information into the order processing system based on a customer's order. For example, the customer might look through a catalog or on a web page for the product desired and call the user to place an order for the particular product or select the product on the web page. Each product in the catalog or on the web page has a unique product number. In the same manner as described above, the customer can place an order for multiple products. For example, the customer might order two servers, a CD burner, a monitor, and a printer. The order processing system is configured to create a record of the order information, which might includes an order number, invoice number, invoice date, line item number, unique product number of each product, marketing product description, serial number of each product, quantity by line item, unit price by line item, amount by line item (quantity×unit price), delivery method, delivery date, ship to address, sold to address, and sold by address.

Using the order information, the order processing system 14 determines which distribution center 18 can supply the goods by first determining the distribution centers that are within a certain area of the ship to address. Once the distribution centers are identified, the order processing system selects a distribution center that has the product in stock, can sell the product with the supplier discount (if any), and can ship the product within the allotted time. Once the distribution center is selected, the order processing system creates an order request using the order information and sends the order request to the central processing system 16. The order request might include a plurality of codes that represent the order information. Each code might be a series of alphanumeric characters. For example, the code for a ship to address in the United States might be represented as “US”. One of the plurality of codes is a consignee code that represents the consignee or recipient of the goods.

The central processing system is configured to receive the order request and verify the accuracy of the order request. For example, if the possible codes for the supplier discount are 10, 20, and 30, but a 25 is received, the central processing system detects an error with the supplier discount code. If the central processing system detects one or more errors with the plurality of codes then the order request is sent back to the order processing system 14 for modification to the particular entry of the order information. Once the order information is modified, the order request is sent to the central processing system to once again verify the accuracy of the plurality of codes.

If the plurality of codes are correct, the central processing system 16 groups or organizes the order request into categories and line items. For example, the order request can be grouped by category, i.e., product type, to form a plurality of line items. Each line item might include the category, the number of products desired for each category, and the delivery date. For example, the product type might be printers, the number of printers desired might be 1,000, and the delivery date might be Oct. 1, 2001. The categories might also be organized based on the ship to information. That is, all printers being shipped to the east coast might be grouped together and all printers shipped to the west coast might be grouped together. The information contained in each line item is then sent to the appropriate distribution center 18. For example, the categories relating to printer orders might be sent to the printer distribution center.

The distribution center 18 is a warehouse that assembles or manufactures the products and has a SAP / ERP system, Oracle system, or Legacy computer systems. The system at the distribution center is configured to receive the order request, i.e., the plurality of codes, which is typically received in the form of a plurality of line items, from the central processing system 16, and to determine whether the order request can be completed in the requested time period and whether the terms of the order request are acceptable to the distribution center.

If the system accepts the order request, then an accept response is sent to the order processing system 14 and the distribution center proceeds to process the order request and ship the products to the ship to address. If the system rejects the order request, then a reject response is sent to the order processing system. The reject response indicates that the distribution center is unable to process the order request due to time, material or labor constraints. If the system sends a reject response, the order processing system might modify the requested time period or the terms of the order request and resends the order request to the system at the distribution center. Once the products are shipped, the system generates a billing statement for the products using the order request that is sent to the central processing system 16. The order processing system can simultaneously or alternatively send the order request to other systems at different distribution centers.

Using the billing statement, the central processing system 16 determines whether a discount code is present in the plurality of codes. If the discount code is present, the central processing system sends the billing file to the rebilling system 20. The rebilling system applies the discount code, i.e., an inter-corporate (IC) discount, to the billing statement and then generates a billing file that is sent to the server 24. If no discount code is present, the central processing system generates a billing file and sends the billing file to the server. The billing file is generated using information from the billing statement. For example, the billing file can be made up of a plurality of billing statements.

The server 24 is configured to receive the billing file, to read and parse the billing file, to organize each billing file according to a particular category, i.e., ship to country, and to create customs invoices for a particular country using information contained in the billing file. Once the billing file is received, the server is configured to adjust the value of the goods based on the discount code. The server uses the country code to determine the format of the customs invoice from the tables, e.g., customs invoice configuration tables, managed in the server. Information pertaining to each country is input into tables contained in the server. Further, the server is configured to group the products from the billing file into a list sorted by product number and country code, and to delete duplicate product numbers from the list. Using the product number and the country code as the query, the server makes a call to the product regulatory reference server 28, which returns a classification number, i.e., a local HTS number, for the product, an export control commodity number (ECCN), and an acceptable description of the goods. For further details regarding the product regulatory reference server, refer to copending U.S. patent application Ser. No.______ (Attorney Docket No. 10002302-1), entitled “Regulatory Classification System”, filed concurrently with this application and owned by a common assignee. Each product number has a unique ECCN. The local HTS number, the ECCN, and the acceptable description of the goods are returned and incorporated into the billing file. The server creates a customs invoice for the particular country using the billing file and creates an encrypted electronic file of the customs invoice. The server also creates an envelope containing the encrypted electronic file and serializes the envelope. The encrypted electronic file is stored in the database 24 and the envelope is transmitted via email to an email address that is accessed by the client device 30. To obtain the email address, the server retrieves the consignee code from the billing file, finds the consignee code in one of the tables, and retrieves the corresponding email address, which is stored in the same table. All customs invoices having the same consignee code are sent to the email address. There can be multiple email addresses assigned to each consignee code.

The ERP system 22 is typically a SAP system, or alternatively an Oracle system. The ERP system is a combination of and performs the functions of the order processing system 14, the central processing system 16, and the system of the distribution center 18. In addition, the ERP is configured to create a billing file and to calculate the value of the products. If the billing statement does not have the discount code, the ERP system creates a billing file and send the billing file to the server. If the billing statement has the discount code, the ERP system sends the billing file to the central processing system for further processing by the rebilling system 20.

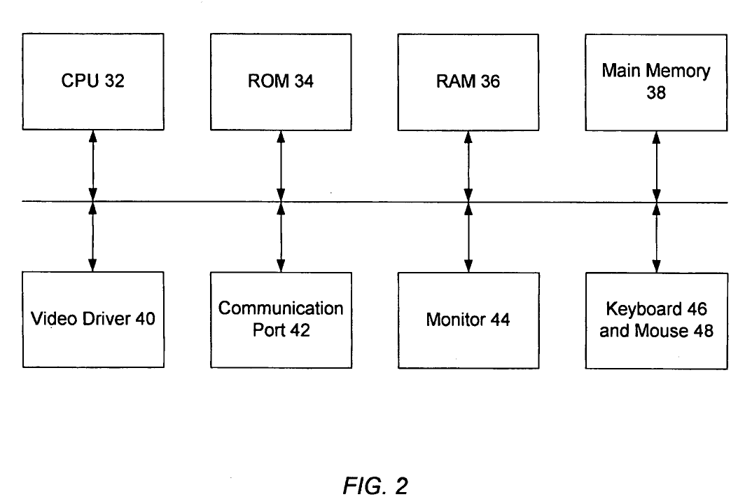

FIG. 2 is a simplified block diagram of the client device 30 of the electronic customs invoice system 12 of FIG. 1. The client device is illustrated as a personal computer (PC). The customs broker uses the client device to display, edit, retrieve, and print the customs invoice.

The PC includes a central processing unit (CPU) 32, a read only memory (ROM) 34, a random access memory (RAM) 36, a main memory 38, a video driver 40, a communication port 42, a monitor 44, a keyboard 46, and a mouse 48. The CPU executes instructions that are stored in the ROM, RAM, and main memory. The ROM is used to store some of the program instructions, the RAM is used for the temporary storage of data, and the main memory is used to store instructions and data. The video driver configures the data received from the CPU so that it can be displayed using the monitor. While the preferred monitor is a CRT, other video display devices may be used including thin film transistor panels. The keyboard and mouse allow the user to edit, retrieve, print, and input information. The communication port is connected to the CPU and interfaces with a modem, cable, DSL line, wireless link, or any other technology connection that facilitates communication amongst the client device 30. The use of the CPU in conjunction with the ROM, RAM, main memory, video driver, communication port, and modem is well known to those of ordinary skill in the art. A standard PC such as an IBM PC, running the software of the present invention, may be used as the client device. One of ordinary skill in the art will know that the client device can include fewer components than described above.

Now referring back to FIG. 1, the client device 30 is further configured to decrypt and manage the electronic file of the customs invoice and allow the customs broker or user the ability to view, edit and print the customs invoice. To view, edit and print the customs invoice, the customs broker or user logs onto their client device and accesses their email account to download the file. Once the file is downloaded, the user can view, edit and print the customs form in the format of the particular country. The client device is also configured to allow the user to edit fields in the customs invoice. The user is given permission to edit certain fields to ensure data integrity. A hidden log or history of the edits to the customs invoice is also stored with the history database in the client device. The user can also assign each customs invoice to a certain group so the user can easily print all the customs invoices that belong to a particular group. For example, all the customs invoices that have the same airway bill number are assigned a group number of 1. Hence, the user can print all the same customs invoices with the same airway bill by inputting 1 as the group number. The user can also create a summary invoice that includes all the customs invoices from a particular group or groups. The summary invoice might include a line item listing of each customs invoice. In sum, the server allows the user to edit, group, and manage customs invoices using the client device.

The foregoing detailed description of the present invention is provided for the purposes of illustration and is not intended to be exhaustive or to limit the present invention to the precise embodiment disclosed. Accordingly, the scope of the present invention is defined by the following claims.

1. An order fulfillment architecture comprising:
an order processing system configured to receive order information and to create an order request using the order information;
a central processing system configured to receive the order request, to verify the accuracy of the order request, and to organize the order request into a plurality of categories;
a system configured to generate a billing statement using the order request; and
a server configured to receive a billing file that is generated using information from the billing statement, to create an electronic file that has a customs invoice for a particular country using information from the billing file, and to transmit the electronic file via email.

2. The order fulfillment architecture of claim 1, wherein the order information is selected from a group consisting of an order number, invoice number, invoice date, line item number, unique product number of each product, marketing product description, serial number of each product, quantity by line item, unit price by line item, amount by line item, delivery method, delivery date, ship to address, sold to address, and sold by address.

3. The order fulfillment architecture of claim 1, wherein the order processing system is further configured to identify a plurality of distribution centers that meet a first predefined criteria relating to the order information.

4. The order fulfillment architecture of claim 3, wherein the order processing system is further configured to select one of the plurality of distribution centers that meets a second predefined criteria relating to the order information.

5. The order fulfillment architecture of claim 1, wherein if the central processing system detects an error in the order request, then the order request is transmitted to the order processing system.

6. The order fulfillment architecture of claim 1, wherein the central processing system is further configured to determine whether the order request contains a discount code.

7. The order fulfillment architecture of claim 6, further comprising a rebilling system configured to apply the discount code to the billing statement.

8. The order fulfillment architecture of claim 7, wherein the rebilling system is configured to generate the billing file.

9. The order fulfillment architecture of claim 1, wherein the billing statement includes a country code.

10. The order fulfillment architecture of claim 9, wherein the server is further configured to create a customs invoice for the particular country as identified by the country code.

11. The order fulfillment architecture of claim 1, wherein the server is further configured to receive a classification number, an export control commodity number, and a description and to incorporate the classification number, the export control commodity number, and the description into the billing file.

12. The order fulfillment architecture of claim 1, wherein the electronic file is encrypted.

13. The order fulfillment architecture of claim 12, further comprising a client device configured to decrypt the encrypted electronic file.

14. The order fulfillment architecture of claim 1, wherein the server is further configured to create an envelope containing the electronic file.

15. The order fulfillment architecture of claim 1, further comprising a client device configured to receive the electronic file and to view the customs invoice.

16. An order fulfillment architecture comprising:
an order processing system configured to receive order information, and to create an order request having a plurality of codes, using the order information, the plurality of codes include a discount code, a country code, and a product code;
a central processing system configured to receive the order request, to verify the accuracy of the plurality of codes, and to organize the order request into a plurality of categories;
a system configured to accept or reject the order request, and to generate a billing statement using the order request;
a rebilling system configured to apply the discount code to the billing statement, and to generate a billing file using information from the billing statement; and
a server configured to create a customs invoice using the billing file, to retrieve the customs invoice using the country code, and to create an electronic file that includes the customs invoice.

17. The order fulfillment architecture of claim 16, wherein the server is further configured to delete duplicate entries in the billing file.

18. The order fulfillment architecture of claim 16, wherein the server is further configured to retrieve a consignee code and an email address corresponding to the consignee code, and to transmit the electronic file to the email address.

19. The order fulfillment architecture of claim 16, wherein the server is further configured to incorporate a classification number, an export control commodity number, and a description into the billing file.

20. The order fulfillment architecture of claim 16, further comprising a client device configured to receive the electronic file and to view the customs invoice.
